(19) United States
(12) Patent Application Publication
(10) Pub. No.: US 2014/0173698 A1
(43) Pub. Date: Jun. 19, 2014

(54) Software publisher and device authentication using customizable multimedia

(71) Applicant: Eric Michael Faccer, Brisbane (AU)

(72) Inventor: Eric Michael Faccer, Brisbane (AU)

(21) Appl. No.: 13/719,120

(22) Filed: Dec. 18, 2012

(51) Int. Cl. H04L 29/06

(52) U.S. Cl. CPC H04L 63/08
USPC 726/4

(57) ABSTRACT

A process for authentication that gives users a warning against malicious web applications is disclosed. The disclosed process gives the user an audiovisual when viewing the correct web application. The audiovisual is known as a “totem” in this document. The totem can be an image that is shown to the user, audio that is played to the user, or a video or animation (with or without audio) that is played to the user. The user selects their totem as part of the disclosed process. The totem is stored locally using web storage in the user's browser. The totem can only be accessed by the correct web application, and thus cannot be presented to the user by a malicious web application seeking to impersonate the correct web application. The disclosed process thus gives the user, even one not “computer savvy”, a strong warning indication about a malicious web applications.

### CROSS-REFERENCE TO RELATED PATENT APPLICATION

Not Applicable

### STATEMENT REGARDING FEDERALLY SPONSORED RESEARCH OR DEVELOPMENT (IF APPLICABLE)

Not Applicable

### REFERENCE TO SEQUENCE LISTING, A TABLE, OR A COMPUTER PROGRAM LISTING COMPACT DISC APPENDIX (IF APPLICABLE)

Not Applicable

### FIELD OF THE INVENTION

The current invention generally relates to authentication of a mobile or other internet-enabled device with a web application publisher.

### BACKGROUND OF THE INVENTION

Web sites and applications (collectively known in this document as web applications) frequently wish to show different content depending on the user. This often includes sensitive information that should not be shared with any other user. For example, online banking should allow a user to view and interact with their own bank accounts but not those of another user. Similarly, the user of an online retailer should be able to view the contents of their shopping cart, but not the cart of another user.

The process of a web application identifying that a particular user is using their application is called authentication. Once authenticated, the web application can then display the content appropriate to the identified user.

Typically, this is done using HTTP cookies. Cookies are small amounts of text stored by a web site on a user's computer through the user's web browser. Each cookie is associated with the domain of the web site it is created by, and can be set and read only by that domain. The cookies associated with a particular domain are sent in each HTTP request to that particular domain. This allows a web application to send content to the user's browser that is specifically appropriate for them, for example, their bank account.

A newer alternative to cookies, which allows a web application to store more information in the user's browser is Web Storage. Web Storage comprises two storage areas: session storage and local storage. Session storage is only accessible within a single browser tab or window session and not of relevance to the long term authentication this patent is concerned with. Local storage is kept between sessions and typically allows a web application to write 5 MB of data that is not accessible to web applications whose publisher has a different domain. Unlike cookies, this data is not sent in every HTTP request, and remains client side unless the web application specifically sends it.

Should a user's cookies be obtained, or similarly, should a user's username and password be compromised, then another, malicious user, would be able to use the web application to access content specific to the intended user, for example, their bank account. An example of how this could occur is if a user is tricked into going to a malicious web application that looks very similar to the web application they desire to visit, for example, by clicking on a link in a malicious email. They may then enter their username and password, thinking they are on the desired web application, which are then recorded by the malicious web application. This is known as a phishing attack.

There is thus a need to give the user some indication that they are on the correct web application. There are some such existing protections for users. For example, they could check the certificates of a web application through the ‘lock’ icon in the address bar. However, successful phishing attacks are still commonly reported, and there is thus a need for better warning indications to users. In particular, warning indications that will work for users who are not “computer savvy”.

Furthermore, the solution should work to authenticate a device, such as a mobile phone, with the publisher of a web application, rather than a single application itself. This allows, for example, the user to update to a later version of a web application, or to use another related application from the same publisher, all without the need to repeatedly authenticate.

### BRIEF SUMMARY OF THE INVENTION

The present invention seeks to provide such a solution. Disclosed is an invention for authentication of a mobile or other internet-enabled device with a web application publisher using customizable multimedia.

According to a first aspect of the present invention, there is provided a method of authenticating a device with the publisher of a web application, the method comprising the steps of:

selecting, upon the first use of a web application from the publisher on the device, a piece of multimedia content as security information that the user will recognize, where the piece of multimedia content is:
an image without audio, a video without audio, an animation without audio, an image with audio, a video with audio, an animation with audio, or pure audio;

storing the selected piece of multimedia content on the device such that it associates the device with the publisher of the web application and is not accessible by another publisher; and

presenting the selected piece of multimedia content to the user as security information upon each subsequent use on the device of a web application from the publisher with which the selected piece of multimedia content is associated with.

According to another aspect of the present invention, there is provided an apparatus for authenticating a device with the publisher of a web application, the apparatus comprising:

a memory for storing a client program;

a memory for storing a server program;

a client processor and a server processor for executing the programs, said programs comprising:

code for selecting, upon the first use of a web application from the publisher on the device, a piece of multimedia content as security information that the user will recognize, where the piece of multimedia content is:
an image without audio, a video without audio, an animation without audio, an image with audio, a video with audio, an animation with audio, or pure audio;

code for storing the selected piece of multimedia content on the device such that it associates the device with the publisher of the web application and is not accessible by another publisher; and

code for presenting the selected piece of multimedia content to the user as security information upon each subsequent use on the device of a web application from the publisher with which the selected piece of multimedia content is associated with.

According to another aspect of the present invention, there is provided a computer program product including a computer readable storage medium having recorded thereon a computer program or programs for directing a server or client processor to execute a method for authenticating a device with the publisher of a web application, said program comprising:

code for selecting, upon the first use of a web application from the publisher on the device, a piece of multimedia content as security information that the user will recognize, where the piece of multimedia content is:
an image without audio, a video without audio, an animation without audio, an image with audio, a video with audio, an animation with audio, or pure audio;

code for storing the selected piece of multimedia content on the device such that it associates the device with the publisher of the web application and is not accessible by another publisher; and

code for presenting the selected piece of multimedia content to the user as security information upon each subsequent use on the device of a web application from the publisher with which the selected piece of multimedia content is associated with.

Other aspects of the invention are also disclosed.

### BRIEF DESCRIPTION OF THE SEVERAL VIEWS OF THE DRAWING

One or more embodiments of the present invention will now be described with reference to the drawings, in which:

FIG. 1 is a flowchart of a process used for authenticating a device with a publisher that provides protection from malicious phishing attempts by way of a totem;

FIG. 2 shows an example of a web application requesting a totem be selected with a file selection UI element during a device's first interaction with the publisher of the web application;

FIG. 3 shows an example of a web application being provided with a totem during a device's first interaction with the publisher of the web application;

FIG. 4 shows an example of a web application displaying the correct totem at the sign-in screen;

FIG. 5 shows an example of a malicious web application displaying the incorrect totem at the sign-in screen;

FIG. 6 shows an example of a web application requesting a totem be selected from a presented number of potential totems during a device's first interaction with the publisher of the web application;

FIG. 7 shows an example of a web application requesting a totem be selected from a presented number of potential totems during a device's first interaction with the publisher of the web application, where a candidate totem has been chosen by the user;

FIG. 8 shows an example of a web application requesting a new totem be selected;

FIG. 9 shows an example of a web application requesting a new totem be selected, where a candidate totem has been chosen by the user; and

FIG. 10 is a block diagram of a computer network upon which the authentication method may take place.

### DETAILED DESCRIPTION OF THE INVENTION

Where reference is made in any one or more of the accompanying drawings to steps and/or features, which have the same reference numerals, those steps and/or features have for the purposes of this description the same function(s) or operation(s), unless the contrary intention appears.

As noted, the current invention generally relates to authentication of a mobile or other device with a web application publisher. From a terminology perspective, the term “device” refers to a piece of electronic hardware and its associated software which is capable of connecting to a web application, and includes mobile telephones, smartphones, electronic personal assistants, tablet computers, laptop computers, desktop computers, and web kiosks. Such a web application is commonly displayed in a browser. From a terminology perspective, the term “browser” refers to a software application on a device that enables navigation and display of web sites and web applications. An application can also run independently of a browser as a separate application on a device.

A process for authentication that gives users a warning against malicious web applications is described below. The described process gives the user an audiovisual when viewing the correct web application. The audiovisual is known as a “totem” in this document. The totem can be an image that is shown to the user, audio that is played to the user, or a video or animation (with or without audio) that is played to the user. The user selects their totem as part of the described process. The totem is stored locally using web storage in the user's browser. The totem can only be accessed by the correct web application, and thus cannot be presented to the user by a malicious web application seeking to impersonate the correct web application. The described process thus gives the user, even one not “computer savvy”, a strong warning indication about a malicious web applications.

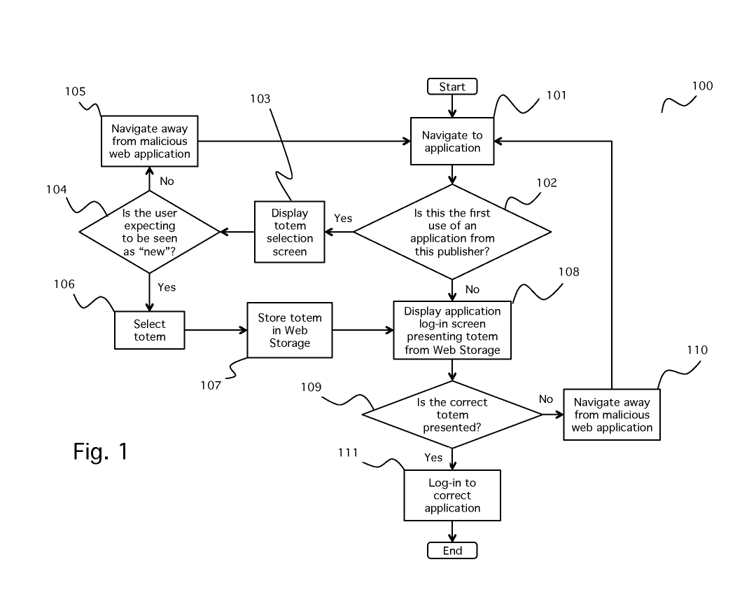

FIG. 1 is a flowchart of process 100 used for authenticating a device with a publisher that provides protection from malicious phishing attempts by way of a totem. The process 100 will now be described in detail with reference to FIG. 1. The process 100 begins at step 101. At step 101 the device navigates to a web application. In the present, first, embodiment, this involves the user of a smartphone or other mobile device using the device's web browser to navigate to the web application. A smartphone user can do this by directly typing the URL of the web application, by following a link from another URL or email, or by using another smartphone application. At step 102 the web application determines whether this is the first visit to a domain of the web application's publisher from the mobile device. In the present embodiment, this is achieved by checking the local storage portion of the Web Storage of the mobile device's browser. If there is no totem stored for the publisher of the web application's domain in the device's browser, then it is determined that either this is the first visit from the device's browser, or the device browser's Web Storage has been cleared. Either way, with no totem stored, the user must pick a totem and the process proceeds to step 103. If instead a totem is found in the device browser's Web Storage for the web application's publisher, then the process proceeds to the log-in screen at step 108.

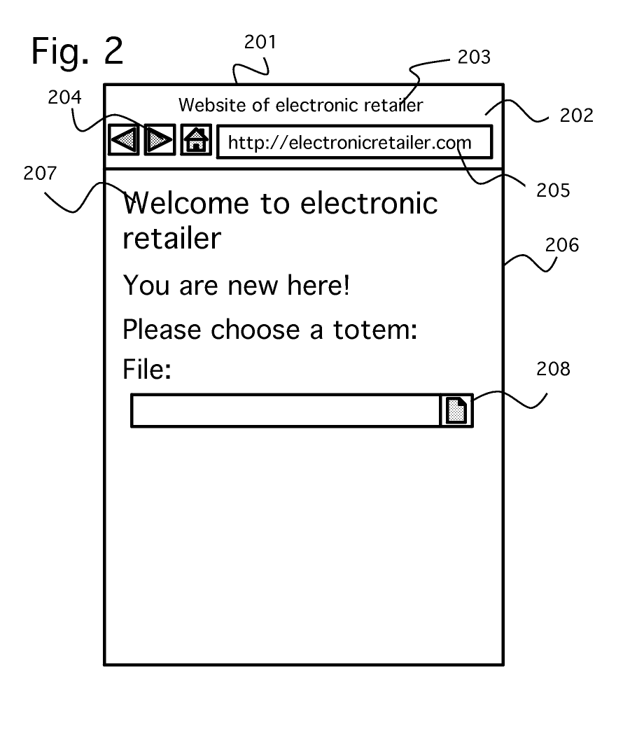

At step 103, the web application prompts the user to select a new totem. An example of the totem selection screen 201 of an example web application is shown in FIG. 2. The user of the device sees their browser's header 202, which in this example includes the web application's title 203, some navigation buttons 204, and an address bar 205 showing the URL of the web application. The web application's graphical user interface 206 is shown below the browser's header. It shows some welcoming text 207 instructing the user to select a totem using a file selection user interface element 208. At step 104, the user decides whether this totem selection screen is what they expected to see. If the user had accidentally navigated to a malicious web application in step 101, instead of the intended web application of a publisher they have previously used, then this request for a totem selection will be unexpected and the user will take appropriate action by moving to step 105, otherwise proceed to select their totem at step 106. At step 105, having determined they are not viewing the web application they intended, the user navigates away from the malicious web application and returns to navigate to the correct web application in step 101. Other action the user may take at step 105 includes informing the publisher of the web application of the likely phishing attempt so they can warn other users of their application. If the user was mistaken and this was in fact their first visit to a web application of the publisher from their device, then contacting support of the publisher will inform them of this and they will then expect to arrive at the totem selection screen.

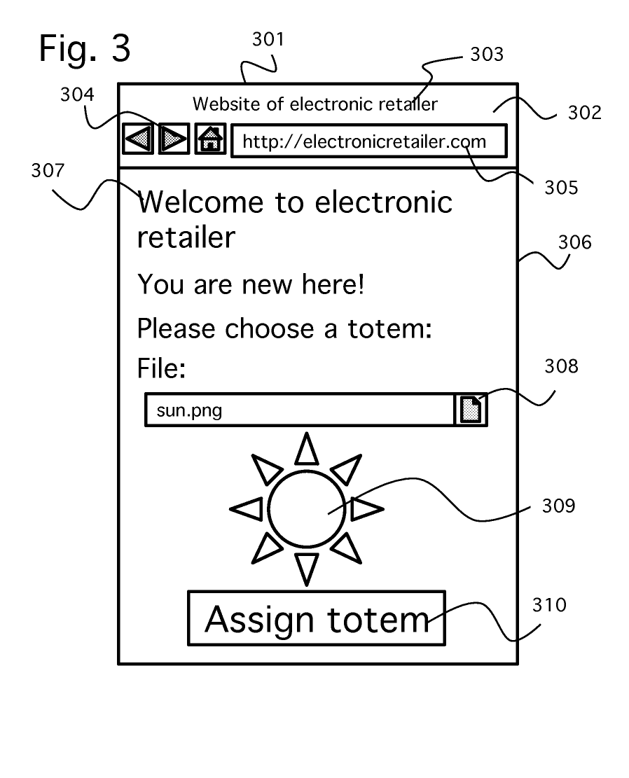

The user selects their totem at step 106. In the present embodiment this selection can be made from any file, for example, a photo, present on the user's device. An example of the totem selection screen 301 with the user having chosen a totem 309 is shown in FIG. 3. The user of the device sees their browser's header 302, which in this example includes the web application's title 303, some navigation buttons 304, and an address bar 305 showing the URL of the web application. The web application's graphical user interface 306 is shown below the browser's header. It shows some welcoming text 307 instructing the user to select a totem using a file selection user interface element 308, which the user has done in selecting ‘sun.png’ in 308, which is the currently selected totem 309. If the user is satisfied with their choice of totem 309, they press the button 310 to proceed to assign the totem in step 107.

At step 107, the totem is stored. This is achieved by the web application directing the device's browser to write the totem into local storage of the Web Storage for the web application publisher's domain. The totem is a multimedia file—an image, video, animation, all potentially with or without audio, or pure audio—which must be converted into a String to be stored in Web Storage. In the example depicted in FIG. 3 the totem 309 is an image. In the present embodiment, Base64 encoding converts the multimedia totem into an ASCII String. Once the totem is stored, the process 100 proceeds to the log-in screen at step 108.

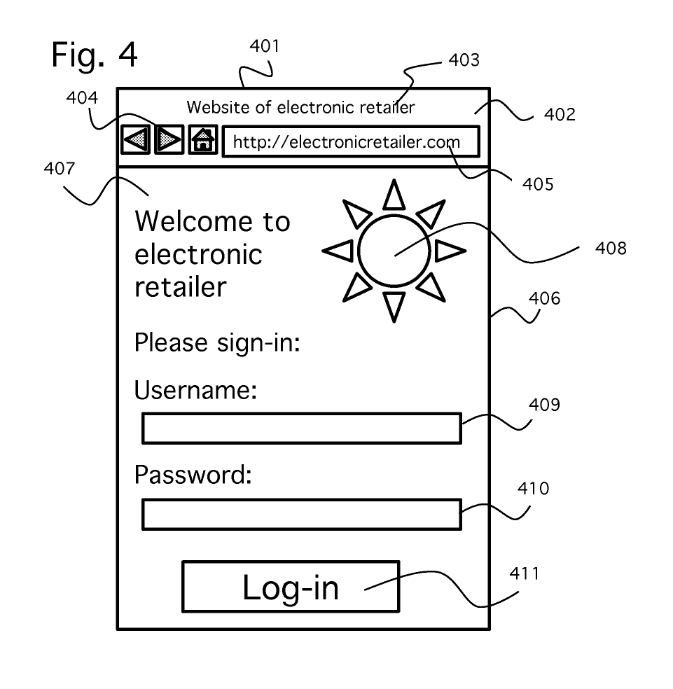

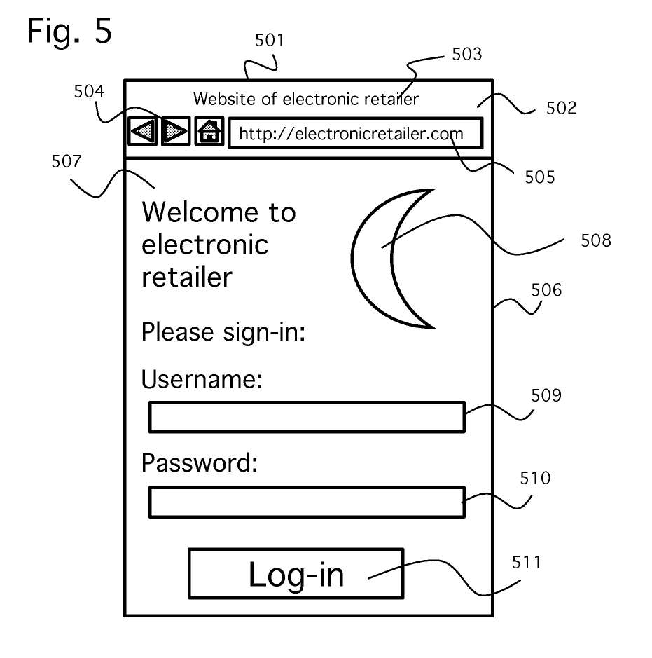

The user is presented with the log-in screen at step 108. An example of the log-in screen 401 presenting the user's totem 408 is shown in FIG. 4. The user of the device sees their browser's header 402, which in this example includes the web application's title 403, some navigation buttons 404, and an address bar 405 showing the URL of the web application. The web application's graphical user interface 406 is shown below the browser's header. It shows some welcoming text 407 instructing the user to sign-in with text boxes for their username 409 and password 410, and a log-in button 411. The totem 408 is shown to the user by the web application from their device browser's Web Storage. It was stored in local storage in step 107. At this step it is retrieved as a String and decoded into a piece of multimedia, in the present embodiment with Base64 decoding. Since the totem is stored in Web Storage on the user's device under the domain of the publisher of the web application, it cannot be presented to the user by the web application of another publisher. A malicious web application making a phishing attempt will not be able to present the correct totem. An example of the log-in screen 501 presenting an incorrect totem 508 is shown in FIG. 5. The user of the device sees their browser's header 502, which in this example includes the web application's title 503, some navigation buttons 504, and an address bar 505 showing the URL of the web application. The web application's graphical user interface 506 is shown below the browser's header. It shows some welcoming text 507 instructing the user to sign-in with text boxes for their username 509 and password 510, and a log-in button 511. At step 109, the user can make a security decision based on if the totem was correctly presented, as in FIG. 4, or not, as in FIG. 5. If the totem is not correctly presented, the user may be experiencing a phishing attempt from a malicious web application and navigates away in step 110. Otherwise, if the totem is correctly presented, the user proceeds to log-in in step 111. At step 110, having determined they are not viewing the web application they intended, the user navigates away from the malicious web application and returns to navigate to the correct web application in step 101. Other action the user may take at step 110 includes informing the publisher of the web application of the likely phishing attempt so they can warn other users of their application.

The process 100 ends at step 111. At this step, the user enters their username 409 and password 410 and presses the log-in button 411. Sign-in of the user's device with the web application is then performed by the web application, and the totem can continue to be presented to the user whilst they use the web application if desired.

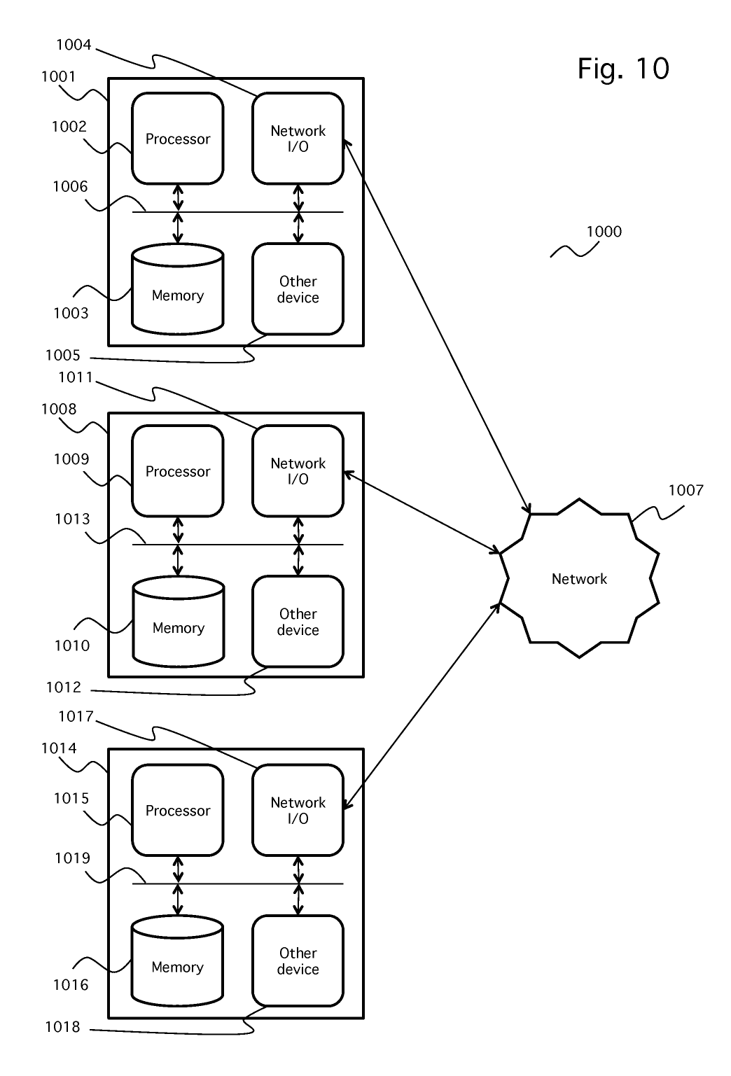

FIG. 10 is a block diagram of a computer network upon which the authentication method may take place. The architecture depicted 1000 consists of a number of computers 1001, 1008, and 1014 which may be clients or servers, connected to a network 1007. In the best mode of the present embodiment: the network 1007 is the Internet; one of these computers 1001 is the client device to be authenticated; and another computer 1008 is the server of the web publisher with which the client device is to be authenticated. There are other computers 1014 also connected to the network. The block diagram's depiction of three computers 1001, 1008, and 1014, is not limiting and there is no limit to the number of connecting computers. Computers 1001 include a processor 1002, a computer readable medium 1003, and a network input/output (I/O) device 1004, such as a modem, able to connect the computer 1001 through the network 1007 with other computers 1008 and 1014. A computer may also include other devices 1005 including, but not limited to, additional processors, additional hard drives, CD or DVD drives, other memory or storage, mice, keyboards, monitors, speakers, microphones, printers, scanners, or other input and/or output devices. The computer components 1002, 1003, 1004, and 1005 typically connect and communicate via a bus 1006 in a manner that results in the usual operation of the computer 1001 well known to those skilled in the art. Similarly, other computers 1008 and 1014, connected to the network 1007, include processors 1009 and 1015, computer readable media 1010 and 1016, and network input/output (I/O) devices 1011 and 1017, such as modems, able to connect the computers 1008 and 1014 through the network 1007 with other devices. These computers 1010 and 1016 may also include other devices 1012 and 1018 including, but not limited to, additional processors, additional hard drives, CD or DVD drives, other memory or storage, mice, keyboards, monitors, speakers, microphones, printers, scanners, or other input and/or output devices. The computer components 1009, 1010, 1011, and 1012 typically connect and communicate via a bus 1013 in a manner that results in the usual operation of the computer 1008 well known to those skilled in the art. Similarly, the computer components 1015, 1016, 1017, and 1018 typically connect and communicate via a bus 1019 in a manner that results in the usual operation of the computer 1014 well known to those skilled in the art.

The user of the device 1001 connects to the server of the web application's publisher 1008 through the Internet 1007. The client's processor 1002 runs the web application client stored in the client's memory 1003, and uses the I/O device 1004 to receive and transmit data necessary for the function of the web application to the server 1008. Similarly, one or more processors 1009 of the web application server 1008 run the web application server stored in some computer readable media 1010, and use the I/O device 1011 to receive and transmit data necessary for the function of the web application to the client device 1001. Importantly, the totem is stored in memory 1003 at step 107 on the client's device 1001. It never leaves the client's device 1001, and neither the server 1008, nor any other computer 1014, has access to it.

In a second embodiment, JavaScript Object Notation (JSON) instead of Base 64 encoding is used to store the totem. At step 107 in this second embodiment, JavaScript Object Notation (JSON) converts the multimedia totem into a String. The String is then stored in Web Storage on the user's device. At step 108 in this second embodiment, the totem is retrieved from Web Storage as a String. JavaScript Object Notation (JSON) converts the String into a piece of multimedia that is presented to the user.

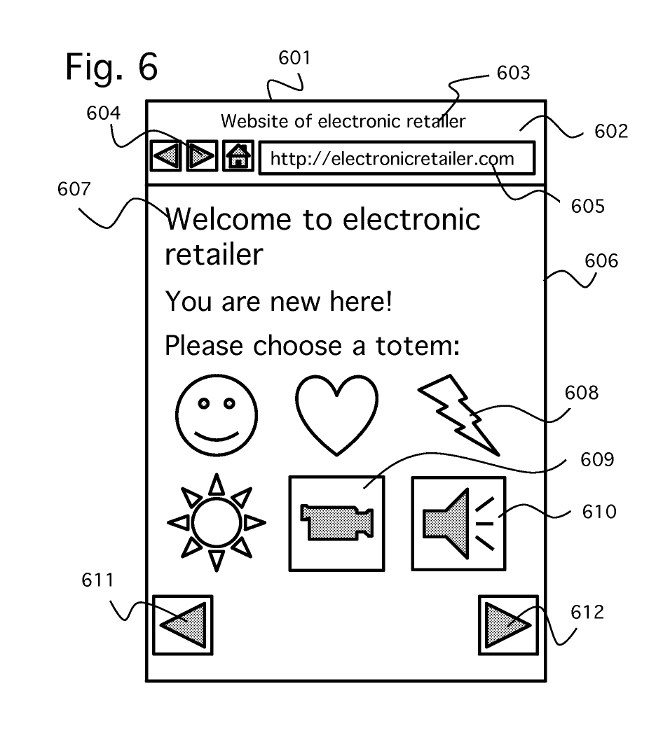

In a third embodiment, at step 103, the totem selection is done not by a file selection UI element, as shown by 208 in FIGS. 2 and 308 in FIG. 3, but instead by presenting a number of potential totems to the user. The web application displays the user with a number of possible totem multimedia files that the user can choose from. This may include multimedia files on their own device. An example of this alternative style of totem selection screen 601 of an example web application is shown in FIG. 6. The user of the device sees their browser's header 602, which in this example includes the web application's title 603, some navigation buttons 604, and an address bar 605 showing the URL of the web application. The web application's graphical user interface 606 is shown below the browser's header. It shows some welcoming text 607 instructing the user to select a totem from a number of presented totems, such as the image totem 608, pure audio totem 609, or movie totem 610. The user can click on an audio totem 609 to play that potential totem. The user can click on an animation or movie totem 610 to play that potential totem including any accompanying audio. Clicking on a potential totem will also select that totem as a candidate totem. Additional potential totems can be presented by using the navigation buttons 611 and 612 if there are more totems from the web application or the user's device than will fit on one screen of the web application's UI.

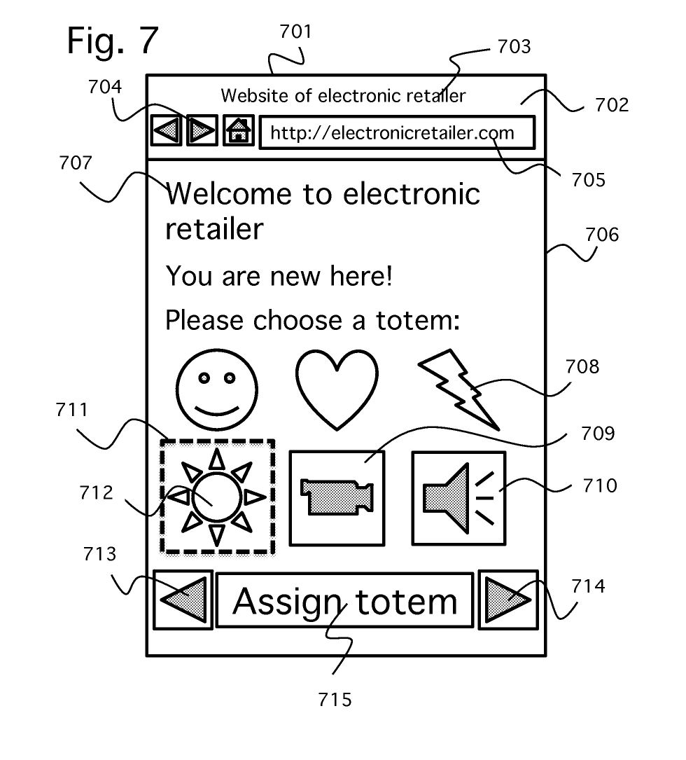

In this third embodiment, at step 106, the totem selection is done using this same alternative UI as for step 103. An example of the totem selection screen 701 with the user having chosen a potential candidate totem 712 is shown in FIG. 7. The user of the device sees their browser's header 702, which in this example includes the web application's title 703, some navigation buttons 704, and an address bar 705 showing the URL of the web application. The web application's graphical user interface 706 is shown below the browser's header. It shows some welcoming text 707 instructing the user to select a totem from a number of presented totems, such as the image totem 708, pure audio totem 709, or movie totem 710. The user has done this by selecting the ‘sun’ totem 712, as indicated by the selection indicator 711. The user can click on an audio totem 709 to play that potential totem. The user can click on an animation or movie totem 710 to play that potential totem including any accompanying audio. Clicking on a potential totem will also select that totem as a candidate totem. Additional potential totems can be presented by using the navigation buttons 713 and 714 if there are more totems from the web application or the user's device than will fit on one screen of the web application's UI. If the user is satisfied with their choice of totem 712, they press the button 715 to proceed to assign the totem in step 107, which is as in the first embodiment.

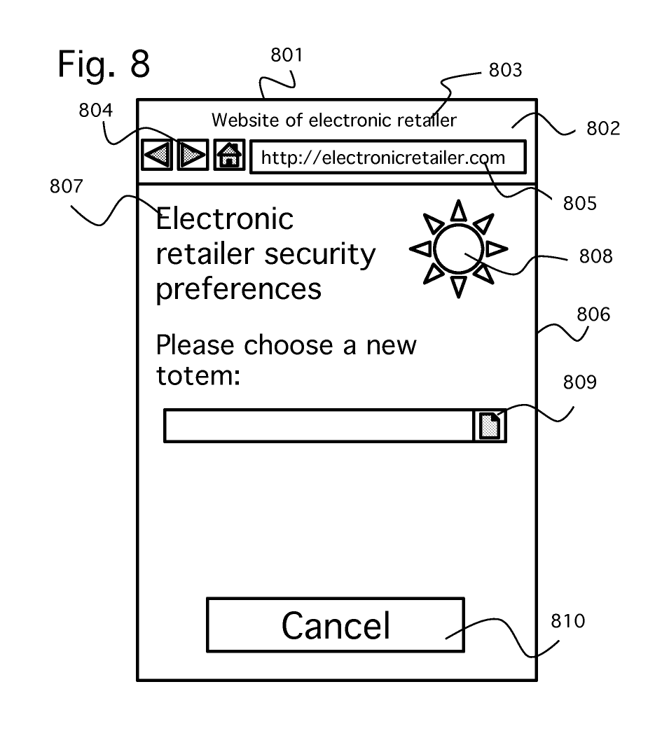

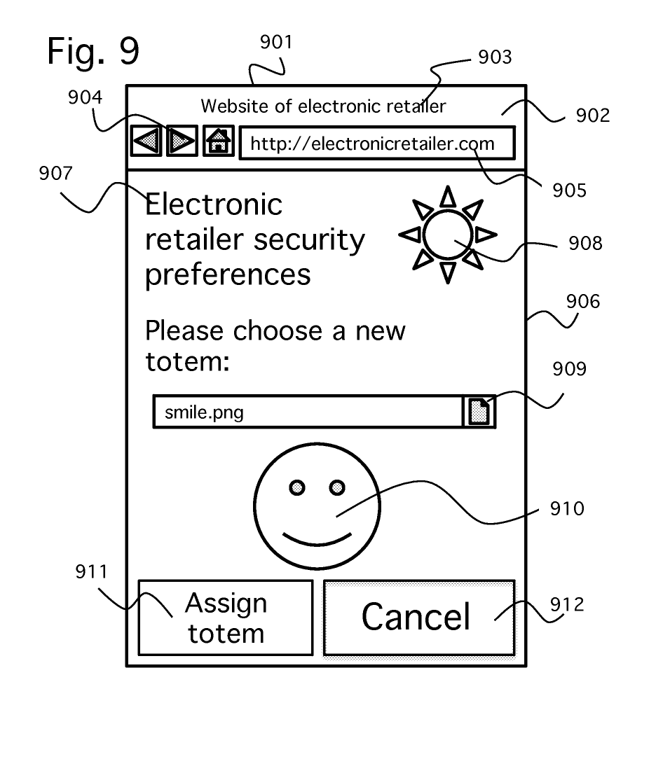

In a fourth embodiment, the totem associating a device with the publisher of a web application can additionally be changed. This change, via selecting a new totem, is a setting available to the user of a web application. An example of the new totem screen 801 is shown in FIG. 8. The user of the device sees their browser's header 802, which in this example includes the web application's title 803, some navigation buttons 804, and an address bar 805 showing the URL of the web application. The web application's graphical user interface 806 is shown below the browser's header. It shows some text 807 indicating the setting screen and instructing the user to select a new totem using a file selection user interface element 809. The user's current totem 808 is also displayed. The user can opt not to select a new totem, and instead keep their current totem 808 by pressing the cancel button 810. An example of the new totem screen where a new totem has been chosen for assignment 901 is shown in FIG. 9. The user of the device sees their browser's header 902, which in this example includes the web application's title 903, some navigation buttons 904, and an address bar 905 showing the URL of the web application. The web application's graphical user interface 906 is shown below the browser's header. It shows some text 907 indicating the setting screen and instructing the user to select a new totem using a file selection user interface element 909, which the user has done in selecting ‘smile.png’, which is the chosen new totem candidate 910. The user's current totem 908 is also displayed. If the user is satisfied with their choice of new totem 910, they press the button 911 to proceed to assign the new totem by storing it in the device's Web Storage as with the first embodiment. The user can opt not to select a new totem, and instead keep their current totem 908 by pressing the cancel button 912.

In a fifth embodiment, a new totem can be selected as in the fourth embodiment. However, rather than from a file selection UI element, the totem can similarly be chosen from number of potential new totems presented to the user. The web application displays the user with a number of possible totem multimedia files that the user can choose from. This may include multimedia files on their own device. This may also include patterns algorithmically generated by the web application. The graphical user interface used for this embodiment is the same as that described in the third embodiment.

In a sixth embodiment, a new totem can be drawn by the user using finger painting on the touch screen of the device, or other drawing tools provided by the web application.

The invention claimed is:

1. A method of authenticating a device with the publisher of a web application, the method comprising the steps of:
selecting, upon the first use of a web application from the publisher on the device, a piece of multimedia content as security information that the user will recognize, where the piece of multimedia content is:
an image without audio, a video without audio, an animation without audio, an image with audio, a video with audio, an animation with audio, or pure audio;
storing the selected piece of multimedia content on the device such that it associates the device with the publisher of the web application and is not accessible by another publisher; and
presenting the selected piece of multimedia content to the user as security information upon each subsequent use on the device of a web application from the publisher with which the selected piece of multimedia content is associated with.

2. A method according to claim 1, wherein said device is a mobile telephone, smartphone, electronic personal assistant, tablet computer, laptop computer, desktop computer, or web kiosk.

3. A method according to claim 1, wherein said web application is a software program, web site, web page, point of sale system, or banking system.

4. A method according to claim 1, wherein the said selecting step determines that this is the first use of a web application from a publisher on a device by checking that there is nothing stored in the Web Storage of the device corresponding to the publisher's domain.

5. A method according to claim 1, wherein the said storing step encodes the said piece of multimedia content into a String and stores the String in the Web Storage of the device.

6. A method according to claim 5, wherein the said encoding of the piece of multimedia content is Base64 encoding.

7. A method according to claim 5, wherein the said encoding of the piece of multimedia content is JSON encoding.

8. A method according to claim 1, wherein the said selecting step selects the piece of multimedia content by the web application prompting the user with a file selection interface whereby the user chooses any piece of multimedia content stored on their device.

9. A method according to claim 1, wherein the said selecting step selects the pieces of multimedia content by the web application presenting the user a plurality of pieces of multimedia content and prompting for the user's choice, where the plurality of pieces of multimedia content may include:
a plurality of pieces of multimedia content already stored on the server of the web application;
a plurality of pieces of multimedia content already stored on the user's device; and/or a plurality of generated patterns.

10. A method according to claim 1, wherein the said selecting step selects the pieces of multimedia content by the web application allowing the user to draw their own totem using finger painting on the touch screen of the device, or other drawing tools provided by the web application.

11. A method according to claim 1, wherein the selected piece of multimedia content used as security information can later be changed by the user of the device.

12. An apparatus for authenticating a device with the publisher of a web application, the apparatus comprising:
a memory for storing a client program;
a memory for storing a server program;
a client processor and a server processor for executing the programs, said programs comprising:
code for selecting, upon the first use of a web application from the publisher on the device, a piece of multimedia content as security information that the user will recognize, where the piece of multimedia content is:
an image without audio, a video without audio, an animation without audio, an image with audio, a video with audio, an animation with audio, or pure audio;
code for storing the selected piece of multimedia content on the device such that it associates the device with the publisher of the web application and is not accessible by another publisher; and
code for presenting the selected piece of multimedia content to the user as security information upon each subsequent use on the device of a web application from the publisher with which the selected piece of multimedia content is associated with.

13. A computer readable storage medium having recorded thereon a computer program or programs for directing a server or client processor to execute a method for authenticating a device with the publisher of a web application, said program comprising:
code for selecting, upon the first use of a web application from the publisher on the device, a piece of multimedia content as security information that the user will recognize, where the piece of multimedia content is:
an image without audio, a video without audio, an animation without audio, an image with audio, a video with audio, an animation with audio, or pure audio;
code for storing the selected piece of multimedia content on the device such that it associates the device with the publisher of the web application and is not accessible by another publisher; and
code for presenting the selected piece of multimedia content to the user as security information upon each subsequent use on the device of a web application from the publisher with which the selected piece of multimedia content is associated with.
